(19) United States
(12) Patent Application Publication
(10) Pub. No.: US 2019/0167514 A1
(43) Pub. Date: Jun. 6, 2019

(54) AN INTER-COUPLE PROXIMITY SENSITIVE STIMULATION SYSTEM FOR USE DURING INTERCOURSE

(71) Applicant: DIGITAL SOUL TECHNOLOGIES PTY LTD, Sydney (AU)

(72) Inventors: Melinda COOPER, Blacktown, Sydney (AU); Sowrabh BEHL, Blacktown, Sydney (AU)

(73) Assignee: DIGITAL SOUL TECHNOLOGIES PTY LTD, Sydney (AU)

(21) Appl. No.: 16/308,155

(22) PCT Filed: Jun. 8, 2017
(86) PCT No.: PCT/AU2017/050571

§ 371 Date: Dec. 7, 2018

Related U.S. Application Data
(60) Provisional application No. 62/358,005, filed on Jul. 3, 2016.
(60) Provisional application No. 62/347,123, filed on Jun. 8, 2016.

(30) Foreign Application Priority Data
Mar. 18, 2017 (AU) 2017900952
May 7, 2017 (AU) 2017901683

(51) Int. Cl. A61H 19/00; A61H 23/02

(52) U.S. Cl. CPC A61H 19/50; A61H 23/02; A61H 2230/625; A61H 2230/505; A61H 2230/305; A61H 2201/165; A61H 2201/5097; A61H 2201/5092; A61H 2201/5084; A61H 2201/5015; A61H 2201/5005; A61H 2230/065

(57) ABSTRACT

In accordance with one aspect, there is provided an inter-couple proximity sensitive stimulation system for use during intercourse, the system comprising: a stimulator wearable, the stimulator wearable comprising: a housing configured for being worn by a wearer during intercourse with a partner yet while allowing sexual penetration by the partner; an erogenous zone stimulation device supported by the housing, a sex partner intercourse proximity detector supported by the housing, the proximity detector configured for detecting an intercourse proximity in use; and a control circuit operably coupled between the intercourse proximity detector and the stimulation device and wherein the control circuit is configured for controlling the stimulation device according to the intercourse proximity.

### FIELD OF THE INVENTION

This invention relates generally to sex toys. More particularly, this invention relates to an inter-couple proximity sensitive stimulation system for use during intercourse to assist couples, especially females to reach climax, and embodiments, control the timing of climax.

### BACKGROUND OF THE INVENTION

During sexual intercourse between couples it may be difficult for both individuals to reach climax or orgasm. For example, when a man and a woman engage in sexual intercourse, often times the man reaches orgasm while the woman does not.

Medical literature has already well established that most females are not able to easily orgasm by penetration alone. Research on 52,000 individuals conducted by Indiana University concluded that only 65% of heterosexual women experience orgasm through sexual intercourse compared to 95% of heterosexual men. Some studies even suggest rates of consistent orgasm through penetration as low as 25% for women. Medical literature has long accepted benefits of orgasm through the process of intercourse not only include reduced stress, increased well-being but is also directly correlated to improve relationship satisfaction. Moreover, research shows 90 percent of men in committed relationships say they care if their partners have reached orgasm.

Sexual stimulator devices exist for a woman to engage in masturbatory activities in order to reach climax. However, such devices, such as dildos and stimulation devices are primarily for solo masturbatory use and, if used during intercourse require manual handling and/or a remote control which are distracting and may actually hinder climax.

Other prior art includes WO 2006/040751 A1 (E.B.T. INTERACTIVE LTD.) 20 Apr. 2006 (D1) which provides a virtual reality sex simulation environment wherein erotic movie sequences are displayed in accordance with user motion sensing.

However, D1 does not recognise nor seek to solve the problem of assisting inter-couple climax during intercourse. Furthermore, D1 is for solo use masturbation and, to the extent that D1 may relate to use for couples, such would involve both couples watching erotic video sequences.

US 2011/0034837 A1 (LEE) February 2011 (D2) discloses a vibratory massage device having contact sensors used for adjusting the vibratory intensities of the device. However, D2 similarly does not recognise nor seek to solve the present problem and has a construction that further prevents sexual intercourse with a partner.

The present invention seeks to provide an inter-couple proximity sensitive stimulation system for use during intercourse, which will overcome or substantially ameliorate at least some of the deficiencies of the prior art, or to at least provide an alternative.

It is to be understood that, if any prior art information is referred to herein, such reference does not constitute an admission that the information forms part of the common general knowledge in the art, in Australia or any other country.

### SUMMARY OF THE DISCLOSURE

As such, with the foregoing in mind, in accordance with one embodiment, there is provided an inter-couple proximity sensitive stimulation system for use during intercourse, the system comprising: a stimulator wearable, the stimulator wearable comprising: a housing configured for being worn by a wearer during intercourse with a partner yet while allowing sexual penetration by the partner; an erogenous zone stimulation device supported by the housing, a sex partner intercourse proximity detector supported by the housing, the proximity detector configured for detecting an intercourse proximity in use; a control circuit operably coupled between the intercourse proximity detector and the stimulation device and wherein the control circuit is configured for controlling the stimulation device according to the intercourse proximity.

The intercourse proximity detector may be configured for detecting a distance between the stimulator wearable and the body of the partner.

The proximity detector may comprise an emitter and a receiver and wherein the proximity detector may be configured for calculating the proximity distance using a reflected signal.

The emitter may be a light emitter and wherein the receiver may be a light-sensitive receiver.

The light emitter may emit one of infrared and ultraviolet light.

The emitter may be an acoustic transmitter and wherein the receiver may be an acoustic receiver.

The system may further comprise a partner wearable and wherein the proximity detector may be configured for detecting the distance between the stimulator wearable and the partner wearable.

The proximity detector may comprise a magnetic flux detector.

The proximity detector may comprise a Hall effect transducer sensor.

The partner wearable may comprise a magnet.

The partner wearable may comprise a ring portion and a plurality of magnets located around the periphery of the ring portion.

Certain of the plurality of magnets may be reversed in polarity and wherein the stimulator wearable may be configured for detecting an rotational orientation of the partner wearable in accordance with the polarity and controlling the stimulation device accordingly.

The proximity detector may comprise a light receiver configured for receiving a light signal emitted by the partner wearable and wherein the proximity detector may be configured for calculating the intercourse proximity in accordance with the signal strength of the light signal.

The light signal may be a transdermal light signal.

Proximity detector may comprise an acoustic receiver configured for receiving an acoustic signal emitted by the partner wearable and wherein the proximity detector may be configured for calculating the intercourse proximity in accordance with the signal strength of the acoustic signal.

The acoustic signal may be a transdermal acoustic signal.

The wearable may comprise an insertable portion and a plurality of contacts sensors there along and wherein the contacts sensors may be wearer facing and wherein the stimulator wearable calculates a depth of insertion utilising the contact sensors.

The wearable may comprise an insertable portion and a plurality of contacts sensors there along and wherein the contact sensors may be partner facing and wherein the stimulator wearable calculates a depth of penetration utilising the contact sensors.

The system may be configured for detecting and arousal state of the wearer and controlling the stimulation device according to the arousal state.

The wearable stimulator may comprise a sensor and wherein the arousal state may be calculated in accordance with sensor data received via from the sensor.

The sensor may comprise at least one of temperature, audio, heart rate and blood pressure sensors.

The system may be further configured for controlling the stimulation device according to a climax timing parameter and the arousal state.

The system may be configured for detecting and arousal state of the partner and controlling the stimulation device to synchronise the timing of climax of the wearer and the partner according to the arousal state of the wearer and the partner.

The control circuit may be configured for detecting a first intercourse proximity and controlling the stimulation device in accordance with a first vibratory configuration setting and detecting a further intercourse proximity and controlling the stimulation device in accordance with a second vibratory configuration setting.

The control circuit may be configured for calculating a proximity distance derivative and controlling the stimulation device in accordance with the proximity distance derivative.

The proximity distance derivative may comprise at least one of frequency and acceleration.

The stimulator wearable may comprise a further stimulation device and wherein the control circuit may be configured for controlling the stimulation device and the further stimulation device separately.

The stimulator wearable may comprise an insertable portion and an exposed portion and wherein the insertable portion may comprise the stimulation device and wherein the exposed portion may comprise the further stimulation device and wherein the control circuit may be configured for controlling the stimulation device independently for G-spot stimulation and the exposed portion for clitoral stimulation.

The system may further comprise at least one auxiliary stimulator wearable in operable communication with the stimulator wearable and wherein the auxiliary stimulator wearable further may comprise a further stimulation device and wherein the stimulator wearable may be configured for controlling the auxiliary stimulator wearable for controlling the stimulation device accordingly.

The stimulator wearable may comprise a motion sensor and wherein the control circuit may be configured for controlling the stimulation device in accordance with motion detected by the motion sensor.

The motion sensor may comprise at least one of accelerometer and gyroscopic transducers.

The proximity detector may comprises a wireless receiver and the partner wearable may comprises detector comprising both an emitter and a sensor configured to detect signal reflected by the wearer's body and the partner wearable may be configured for transmitting a signal indicative of the intercourse proximity to the wireless receiver

Other aspects of the invention are also disclosed.

### BRIEF DESCRIPTION OF THE DRAWINGS

Notwithstanding any other forms which may fall within the scope of the present invention, preferred embodiments of the disclosure will now be described, by way of example only, with reference to the accompanying drawings in which:

FIGS. 1-4 show various functional componentry configurations of a stimulator system in accordance with various embodiments;

FIGS. 5 and 6 show a digital microprocessor implementation of a wearable stimulator including the associated computer code instruction modules in accordance with an embodiment;

FIGS. 7-49 show various physical embodiments of wearables in accordance with the various embodiments;

FIGS. 50 and 51 show differing stimulation regimes according to intercourse proximity; and

FIG. 52 shows various illustrative functionality of the system in accordance with embodiments.

### DESCRIPTION OF EMBODIMENTS

FIGS. 1-4 show various functional componentry configurations of an inter-couple intercourse proximity sensitive stimulation system 6 for use during intercourse. The system 6 comprises a stimulator wearable 1. The stimulator wearable comprises a housing configured for being worn, or at least used during sexual intercourse. The stimulator wearable 1 further comprises an erogenous zone stimulation stimulator device 2 supported by the housing.

The wearable 1 further comprises an intercourse proximity detector 3 which may comprise a proximity sensor 3S supported by the housing configured for detecting a sex partner intercourse proximity 4 in use.

In embodiments, the partner intercourse proximity may represent distance between the couples (i.e. long or medium-range distances) or depth of penetration (i.e. short range or contact proximity). The long-range non-contact proximity distance may represent several metres so as to, for example, be indicative of whether the couples are in the same room and the medium range non-contact proximity may represent foreplay between the couples whereas the short range contact distance may represent actual penetration. As such, in embodiments, the system 6 is able to control the stimulation device 2 according to these different scenarios.

The wearable 1 further comprises a control circuit 5 operably coupled between the intercourse proximity detector 3 and the stimulation device 2 and wherein, as will be described in further detail below, the control circuit 5 is configured for controlling the stimulation device 2 according to the intercourse proximity 4.

In embodiments that follow, there will typically be described the utilisation of the system 6 between male and female sexual partners. However, such as primarily for illustrative convenience and it should be noted that the system 6 may equally be utilised for bisexual couples, such as between two females and two males.

The embodiment shown in FIG. 1 shows the stimulator wearable 1 in a stand-alone configuration wherein only one sex partner wears the stimulator wearable 1 during intercourse, such as the female. In this embodiment, the stimulator wearable 1 detects intercourse proximity 4 between the stimulator wearable 1 and the partner's body, such as the male partner's groin, abdomen or the like so as to be able to control the stimulation device 2 accordingly.

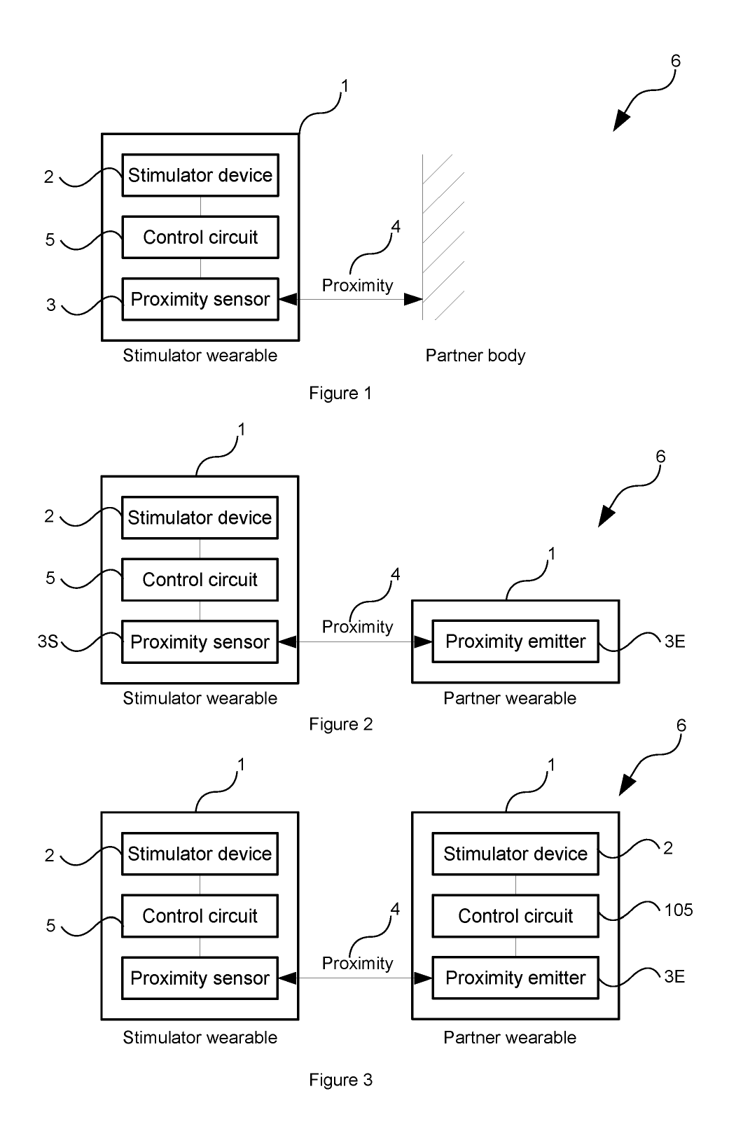

FIGS. 2 and 3 show an embodiment of the system 6 wherein a pair of wearables 1 are utilised comprising a stimulator wearable 1 and a partner wearable 1.

For example, the stimulator wearable 1 may be worn by a female partner and the partner wearable 1 worn by the male partner during intercourse. In these embodiments, the wearables 1 are in operable communication with each other, including for the purposes of detecting the intercourse proximity 4 and, in embodiments, transmitting data between the wearables 1.

In the embodiment shown in FIG. 2, the partner wearable 1 comprises a proximity emitter 3E configured for emitting a signal which is detected by the intercourse proximity sensor 3S as will be described in further detail below.

FIG. 3 shows an embodiment wherein both wearables 1 provide stimulation. In this regard, and as is represented, both wearables 1 comprise stimulation devices 2 which, embodiments, may be controlled independently, by associated independent control circuit.

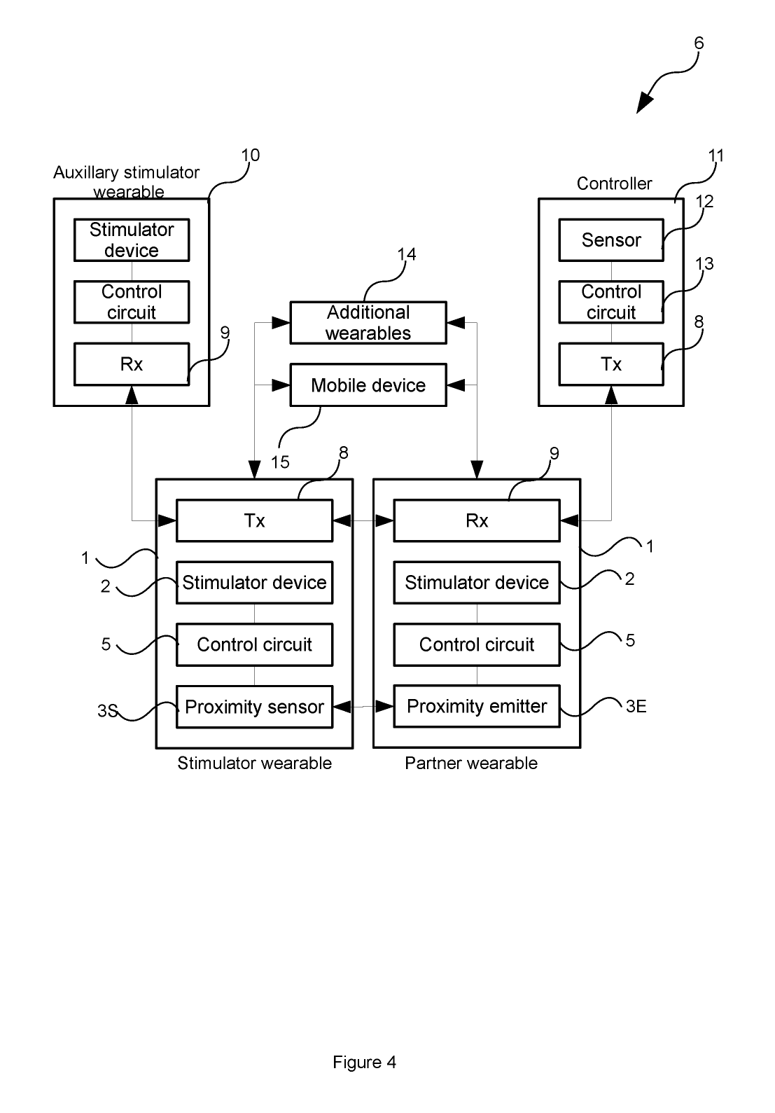

FIG. 4 shows a further potential functional componentry configuration involving the stimulator wearable 1 and the partner wearable 1. In the embodiment shown, the wearables 1 may comprise the stimulation devices 2 and associated control circuit and intercourse proximity detector 3. However, as alluded to above, in an embodiment, the wearables 1 may comprise data connectivity interfaces and the form of transmitters 8 and receivers 9 for sending data between the wearables 1 and other potential peripheral componentry. Preferably, the data interface is a wireless interface and, in this regard, various wireless interfaces may be utilised, such as Bluetooth, near field communication, Wi-Fi wireless interfaces and the like.

In the embodiment shown, the stimulator wearable 1 may be in operable communication with one or more auxiliary stimulator wearables 10. For example, the main stimulator wearable 1 may provide a clitoral stimulation wherein a pair of auxiliary stimulator wearables 10, in operable communication with the stimulator wearable 1, such as by utilising a Bluetooth data interface, may provide nipple stimulation.

Additionally, the wearables 1 may be in operable communication with a controller device 11, again preferably across a wireless data interface. In such an embodiment, the controller 11 may be utilised for dynamically configuring the functionality of the wearables 1.

For example, the controller device 11 may comprise a sensor 12 or user interface input operably coupled to an associated control circuit 13 configured for transmitting data to either or both of the wearables 1 to control the functionality thereof. For example, the sensor 12 may be dynamically adjusted by either partner during intercourse to control the stimulation as to, for example, speed or defer the reaching of climax.

In embodiments, as opposed to requiring user control, the sensor 12 may sense various parameters so as to be able to substantially autonomously control the stimulation devices 2. For example, the sensor 12 may sense the various limb positions of the wearer, including in determining a distance between the controller 11 and, for example, the partner wearable 1. In accordance with this embodiment, for example, the male user may perform a hand gesture allowing the system 6 to dynamically control the stimulation device 2 of the female's wearable accordingly. In yet further embodiments, as opposed to the sensor 12 detecting limb position, the sensor 12, for example, may be a mouth wearable so as to, for example, determine tongue position gestures so as to control the stimulation device 2 similarly.

In embodiments, as will be described in further detail below, the system 6 may be configured for detecting and arousal state of one or both partners (such as by using additional sensors) so as to be able to control the stimulation device 2 so as to control the timing of climax. Also, in these embodiments, the system 6 may be configured for detecting and arousal state of the male partner so as to dynamically adjust the stimulation device 2 so as to seek to synchronise the climax of the female user.

In embodiments, the wearables 1 may interface with additional wearables 14 so as to be suited for multi-partner use.

Furthermore, in an embodiment, the system 6 may interface with peripheral computer devices, such as a mobile phone device 15 comprising an executable software application “app” allowing for the setting of various operational settings, dynamic control of the stimulation device 2 and the like. In embodiments, post sex feedback may be provided by the mobile device 15, such as whether climax was achieved, the timing of climax and the like so as to allow the system 6 to dynamically adjust various settings so as to seek to optimise the operation of the stimulation device 2 so as to optimise various parameters, including optimising the probability of climax and the synchronisation of climaxes.

In embodiments the wearables 1 may comprise analog componentry. For example, the intercourse proximity sensor 3S of the stimulator wearable 1 may comprise a magnetometer sensor (such as a Hall effect sensor) or magneto resistive sensor configured for measuring magnetic flux of a magnet of the associated partner wearable 1 and wherein the magnetometer sensor is in operable communication with an operational amplifier circuit which powers a stimulation device accordingly.

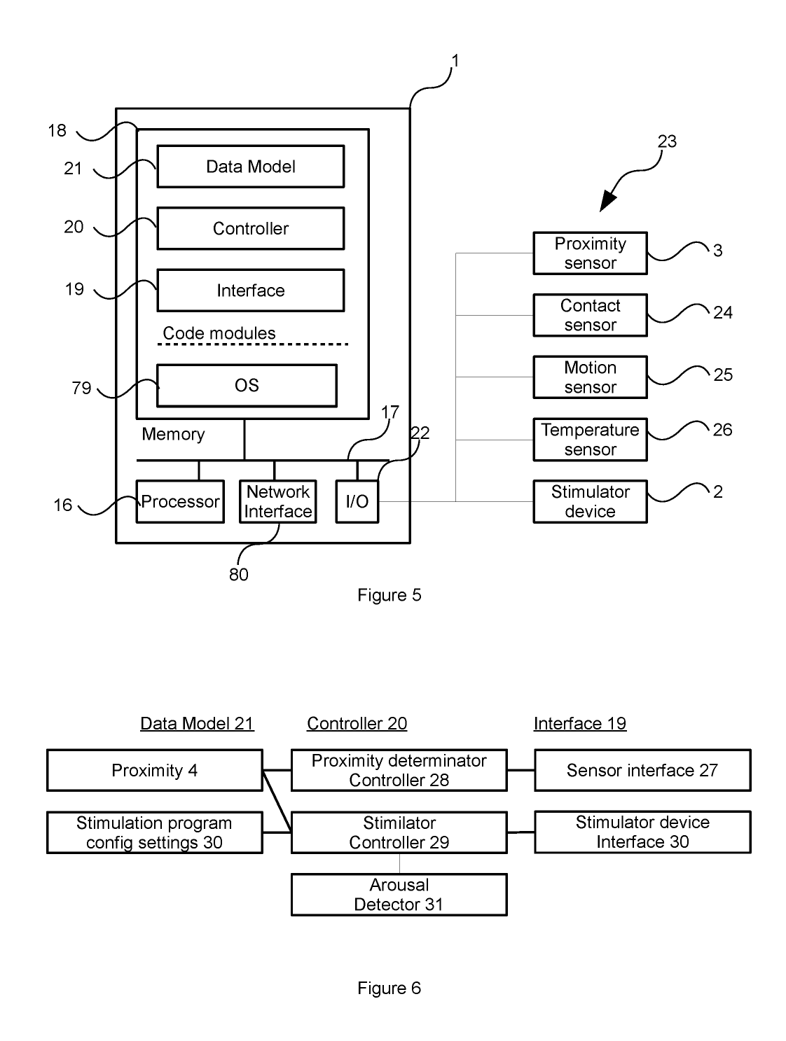

However, FIG. 5 shows an embodiment wherein the wearables 1 have digital implementation.

In the embodiment shown, the wearable comprises a microprocessor 16 for processing digital data. In operable communication with the processor 16 across a system bus 17 is a memory device 18. The memory device 18 is configured for storing digital data including computer code instructions and associated program data. As such, in use, the processor 16 fetches such instructions and data from the memory device 18 for execution.

The memory device 18 may store an operating system 79.

The wearable may comprise an I/O interface 22 configured for interfacing with various peripheral devices 23.

In the embodiment shown, the peripheral devices 23 may comprise the intercourse proximity detector 3. However, in various embodiments, additional peripheral devices 23 may be employed such as a contact sensor 24 for detecting body contact (such as partner body contact, depth of penetration contact or the like).

The peripheral devices 23 may further comprise a motion sensor 25 to detect motion of the wearable which, for example, may comprise an accelerometer and gyroscopic transducers. As such, in this embodiment, the wearable may configure the stimulation additionally, or alternatively, in accordance with motion, such as frequency, amplitude and direction.

The peripheral componentry 23 may, in embodiments, further comprising a temperature sensor 26. As alluded to above, embodiments, the temperature sensor 26 may be configured for determining an arousal state so as to allow the wearable to dynamically control the stimulation device 2 to, for example, adjust the timing of climax.

There is also shown the peripheral devices 23 comprising the stimulation device 2. Other peripheral devices 23 may also be employed.

As is shown, the computer code instructions of the memory device 18 may be divided into various computer code modules which, for illustrative convenience, have been shown as interface modules 19, controller modules 20 and data modules 21 as will be described in further detail below with reference to FIG. 6.

In general terms, the interface 19 performs interfacing functions, such as interfacing with various peripheral devices and/or user interfaces. The data model 21 stores various data relating to the operation of the wearable including program settings and the like. The controller 20 may interface the data model 21 and the interface module 19 and perform various computer processing functionality described herein.

FIG. 6 shows an exemplary data model, control and interface module representation illustrative of the various data, processing and functionality of the wearable.

Specifically, there is shown the interface modules 19 comprising a sensor interface 27 which may interface with various sensors, such as the intercourse proximity detector 3. The sensor interface 27 may interface with an intercourse proximity determinator controller 28 which determines the intercourse proximity 4 in accordance with the sensor data interpreted by the sensor interface 27.

The intercourse proximity determinator controller 28 may store the intercourse proximity 4 within the data model 21. It should be noted that various derivative calculations may be calculated in accordance with the intercourse proximity, such as penetration frequency which may be additionally utilised in embodiments for controlling the stimulation device 2.

The controller modules 20 may further comprise a stimulator controller 29 configured for controlling the stimulation device 2 via a stimulation device interface 30.

As is shown, the stimulator controller 29 may perform simulation functionality in accordance with various stimulation programs/configurations settings 30 including those described in further detail below.

As also alluded to above, the controller modules 20 may comprise an arousal detector controller 31 configured for detecting, or at least estimating, a state of arousal of at least one partner so as to be able to allow the stimulator controller 29 to dynamically adjust the operation of the stimulation device 2, so as to, for example, speed or defer the reaching of climax.

For example, the arousal detector 31 may detect various arousal indicative parameters of the wearer's, such as blood pressure, heart rate, body temperature, vocal output and the like utilising various appropriate sensors, including the temperature sensor 26. As such, when, for example, seeking to control the stimulation devices 2 such that partners reach climax substantially simultaneously, the stimulator controller 29 may increase the vibrational intensity of a stimulation device 2 of a partner been detected as being further away from arousal as opposed to the other partner.

In certain embodiments, the system 6 may provide arousal indicative haptic feedback to one of the partners wherein, for example, having detected in arousal state of, for example, the female partner, the male wearable 1 may provide arousal state indicative haptic feedback such as by using increasing frequency or intensity, such that the male partner is able to surreptitiously ascertain the arousal state of the female.

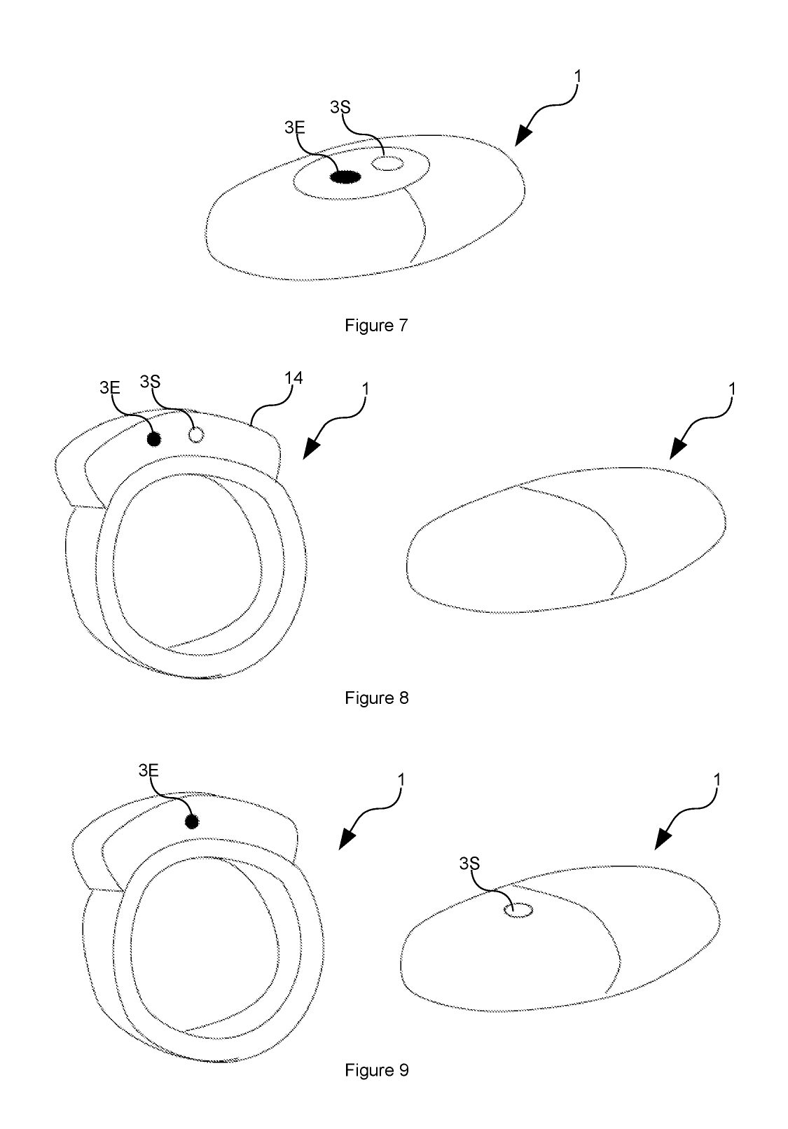

There will now be described various physical embodiments of the wearables with reference to FIGS. 7 to 49.

Specifically, FIG. 7 shows an embodiment of the stimulator wearable 1 in the aforedescribed stand-alone configuration.

In this embodiment, the wearable 1 comprises both the proximity emitter 3E and the proximity sensor 3S configured for detecting reflected signals from the body of the partner. For example, the emitter 3E and sensor 3S may be light beam or acoustic transducers wherein the sensor 3S is configured for detecting an amount of reflected light or acoustic signal emitted from the emitter 3E. As such, the control circuit 13 determines the amount of reflected signal so as to be able to infer the intercourse proximity 4 therefrom. In embodiments, the co-located emitter/sensor may be contact sensors, such as resistive and/or capacitive sensors so as to detect touch of the partner's body, or at least proximity of the partner's body by variation in capacitance.

In the embodiment shown, the stimulator wearable 1 takes the form of a vibrator which may be mounted by straps or similar over the clitoris of the female user. In this application, the signal is reflected by the body of the male partner, such as the groin or abdomen region of the male partner.

Alternatively, the wearable 1 may be inserted into the vagina wherein depth of penetration of the penis affects the light or acoustic signal detected by the intercourse proximity sensor 3S.

FIG. 8 shows an embodiment wherein a pair of wearables 1 are utilised wherein, as is shown, the stimulator wearable 1 takes the form of a female vibrator and the partner wearable 1 takes the form of a stretchable male penis ring.

In this embodiment, the partner wearable 1 comprises both the proximity emitter 3E and the intercourse proximity sensor 3S orientated from a forward face of electronic housing 32 mounted thereatop. In this embodiment, the partner wearable 1 may stimulate the male user wherein the housing 32 houses the stimulation device 2. However, the partner wearable 1 may comprise a wireless transmitter for transmitting a signal for receipt by the female stimulator wearable 1. For example, the wearables may interface via Bluetooth connectivity wherein, with the partner wearable 1 having inferred the intercourse proximity 4 between the wearables, or between the partner wearable 1 and the body of the female, the partner wearable 1 is able to transmit data via the Bluetooth channel for receipt by the female stimulator wearable 1 which is used to control the stimulation device 2 of the female stimulator wearable 1.

FIG. 9 shows an embodiment wherein the intercourse proximity detector 3 is shared between the wearables. Specifically, as is shown, the male partner wearable 1 comprises the proximity emitter 3E and the female stimulator wearable 1 comprises the proximity sensor 3S.

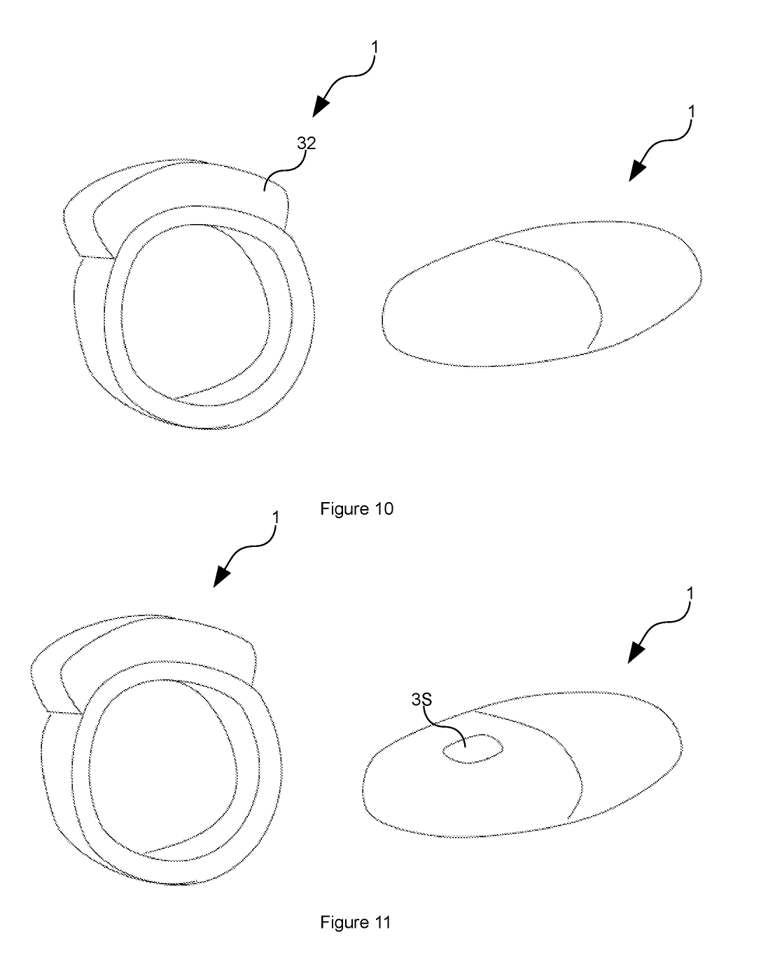

In embodiments, the configuration may be reversed wherein the female stimulator device comprises the proximity emitter 3E and the male partner wearable 1 comprises the proximity sensor 3S but wherein, in this embodiment, the male partner wearable 1 determines the intercourse proximity 4 which is then wirelessly transmitted to the female stimulator wearable 1.

Whereas the embodiments of FIGS. 7-9 generally use line-of-sight intercourse proximity detection between the wearables, FIG. 10 shows an embodiment that utilises non-line-of-sight intercourse proximity detection. In this embodiment, the male partner wearable 1 may comprise an accelerometer and/or gyroscopic transducer within the housing 32 configured for detecting the acceleration and/or orientation of the male partner wearable 1 which is then transmitted wirelessly to the female stimulator wearable 1. This may also be combined with a proximity sensor to enhance detection of penetration.

In embodiments, as opposed to utilising an accelerometer, the wearables may utilise received signal strength intercourse proximity sensing wherein, for example, the male partner wearable 1 comprises a low power Bluetooth beacon configured for transmitting Bluetooth beacon signals, such as every 100 ms. The female stimulator wearable 1 is then able to determine the intercourse proximity 4 in accordance with the strength of the signal received.

FIG. 11 shows an embodiment wherein the male partner wearable 1 is a passive device in that it comprises a magnet. In this configuration, the female stimulator wearable 1 may comprise a magnetometer/magnetic flux sensor 3S, (such as a Hall effect sensor) configured to detect the magnetic flux from the magnet of the male partner wearable 1 so as to be able to infer the intercourse proximity between the wearables.

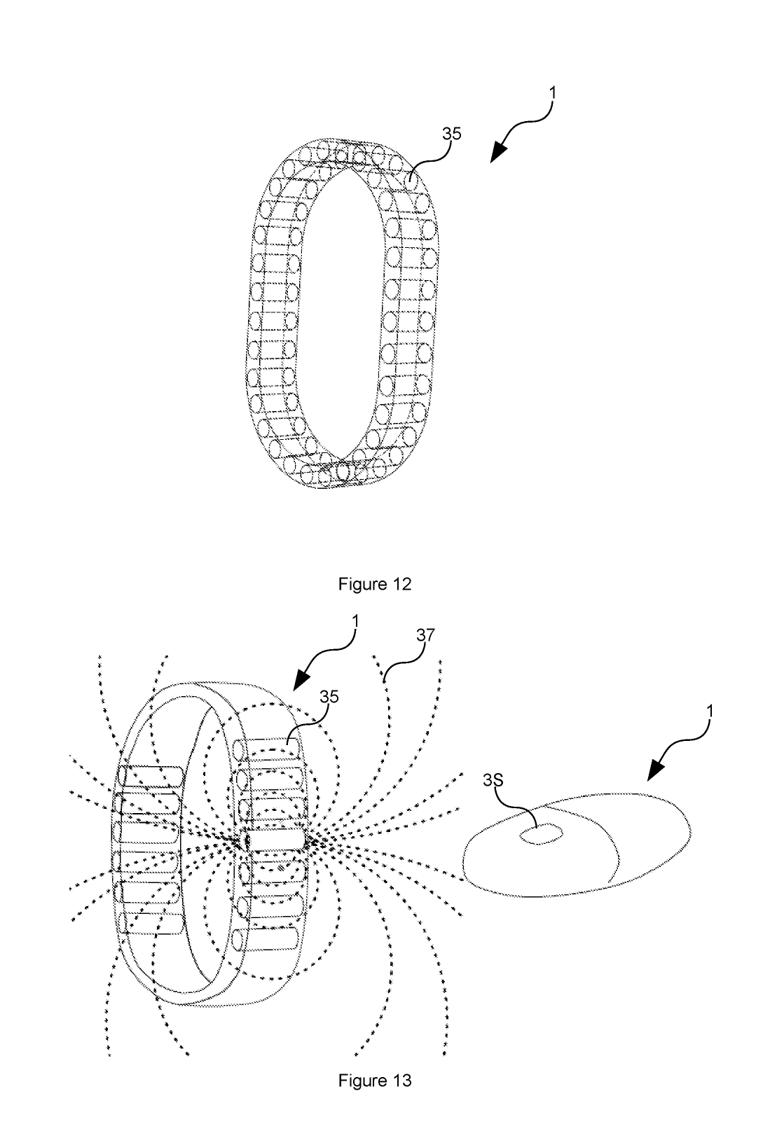

In accordance with this embodiment, FIGS. 12 and 13 show an embodiment wherein the male wearable 34 comprises a plurality of peripheral magnets 35 generating a magnetic flux 37 which is detected by the Hall effect sensor 3S. The embodiment shown in FIG. 2 comprises the magnets 35 substantially around the entire periphery of the male wearable 34 so as to enhance sensing ability and rotation invariance.

In embodiments, the polarity of the magnets 35 may be reversed around certain of the periphery of the male wearable 1 such that the female wearable 1 is able to detect the orientation of the male wearable 1 with respect to the female wearable 1. As such, the female wearable 1 may provide different stimulations depending on the orientation of the male with respect to the female.

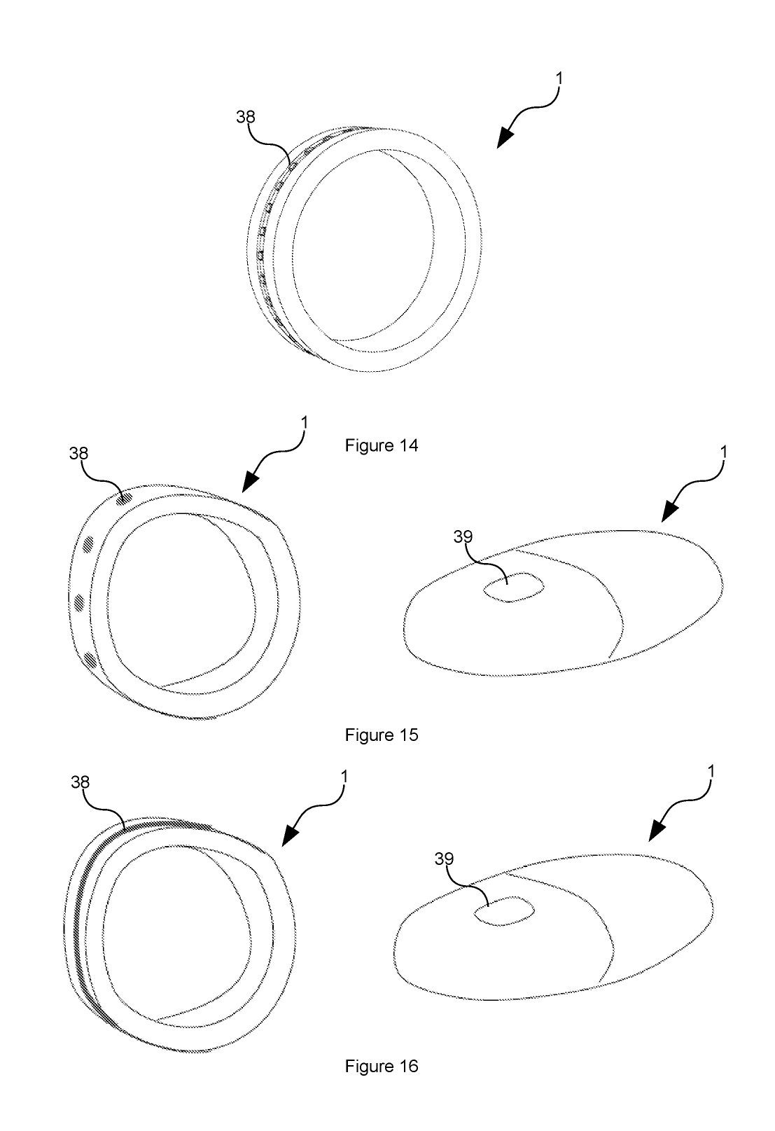

FIGS. 14-16 show embodiments wherein light is utilised for the intercourse proximity detection. The embodiment shown, the male wearable 1 may comprise a plurality of peripheral LEDs emitting light which is detected by a light sensor 39 of the female wearable 1. In an embodiment, the lights 38 may emit visible light, but, in a preferred embodiment, such light is substantially invisible so as to not affect intimacy and may therefore transmit substantially invisible infrared or ultraviolet light.

The embodiments shown in FIGS. 14 and 15 show discrete LEDs 38 whereas the embodiment shown in FIG. 16 shows a strip LED.

In other embodiments, the wearables 1 may emit light using other luminescence means such as photoluminescence or chemiluminescence. For example, the male wearable ring wearable 1 may be coated in a photo-luminescent material that emits light across the entire surface of the ring aiding the ability to be detected by a corresponding female wearable 1 through a light sensor.

In embodiments, the lights 38 transmit light at a certain wavelength or frequency so as to allow the sensor 3S to discriminate between light emitted by the lights 38 and other light sources.

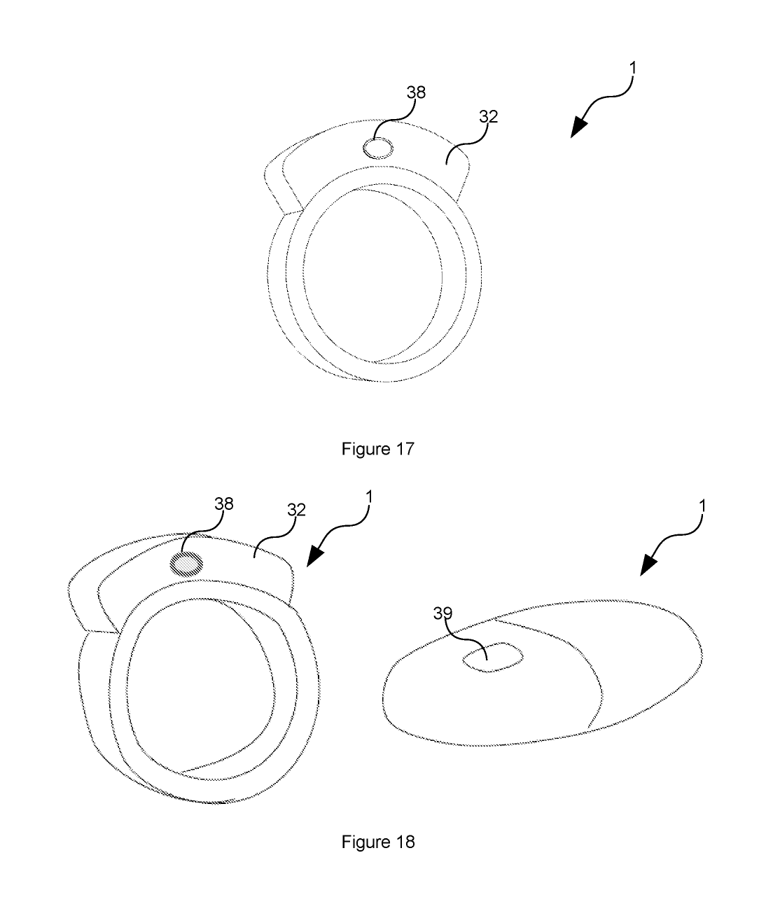

FIGS. 17 and 18 show an embodiment wherein acoustics are utilised to determine the intercourse proximity 4 between the wearables 1. Specifically, in the embodiment shown, the front face of the electronic housing 32 of the male wearable 1 comprises an acoustic transmitter 38 configured for generating an acoustic signal in the direction of the female wearable 1 which comprises an associated acoustic receiver 39.

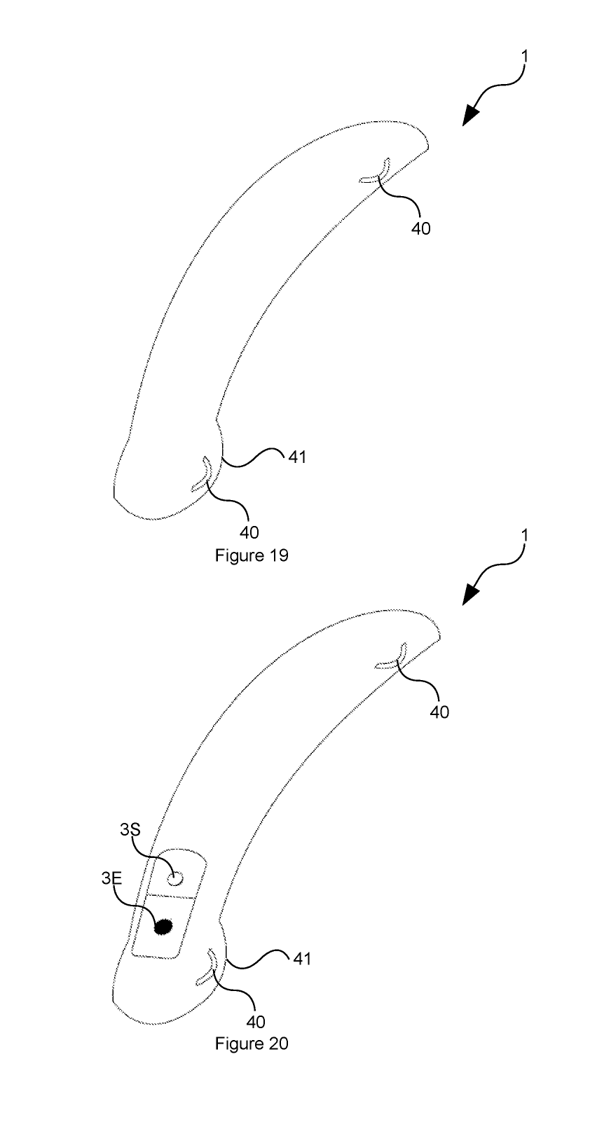

The acoustic transmitter 38 and receiver 39 may operate by line-of-sight or transdermally.

Whereas the aforedescribed embodiments have described the female wearable 36 as comprising a bullet type vibrator device, FIGS. 19 and 20 show a further embodiment wherein the bullet type vibrator device is substantially elongated and which may comprise attachments 40 for securement by way of strapping, such as for fastening to underwear, belts and the like such that the wearable 1 need not necessarily be held in use.

In the embodiment shown in FIG. 20, the female wearable 36 may comprise the detector 3 performing the intercourse proximity determination in the manner described herein. Furthermore, the base 41 may comprise the stimulation device 2.

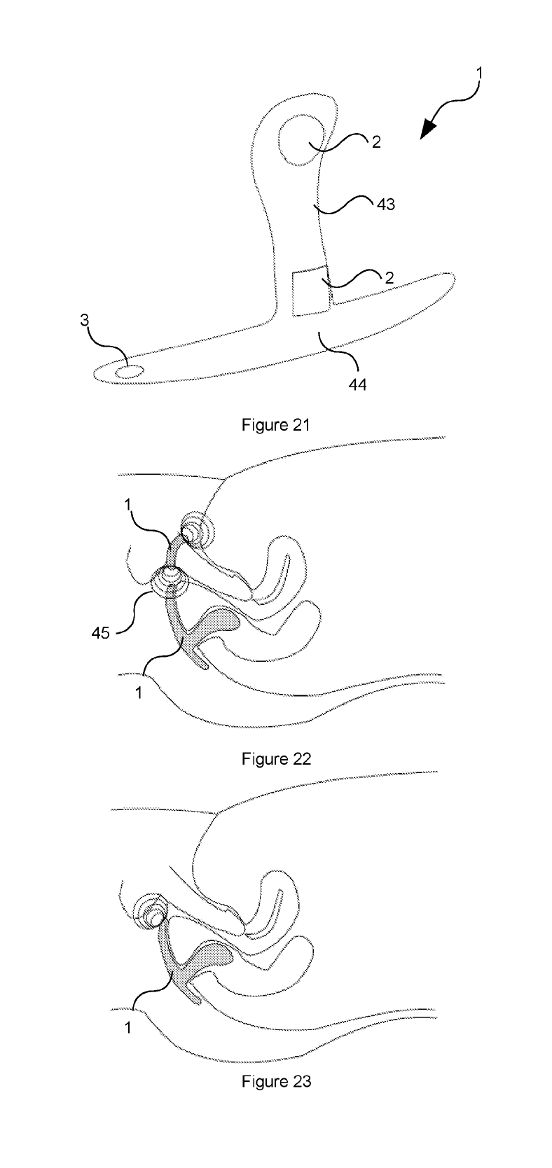

FIG. 21 shows an anal-type wearable 1 comprising an insertable portion 43 and a transverse base portion 44.

In the embodiment shown, the wearable 1 may comprise a pair of stimulation devices 2 so as to stimulate different areas of the wearable 1. Furthermore, as is shown, the proximal end of the base portion 44 may comprise the proximity detector 3.

FIG. 22 shows an embodiment wherein the wearable 1 is located so as to detect signals 45 emitted by an associated cock ring wearable 1.

As is shown, the placement of the sensor and/or emitter 3 on the proximal end of the base portion 44 locate such close to the cock ring device 46 for enhancing signal strength.

The embodiment shown in FIG. 23 shows the wearable 1 utilised in stand-alone configuration wherein the proximal end of the transverse portion 44 comprises both the emitter 3E and the sensor 3S so as to be able to detect reflected signals from the male body, such as those reflected by the adjacent scrotum of the male body.

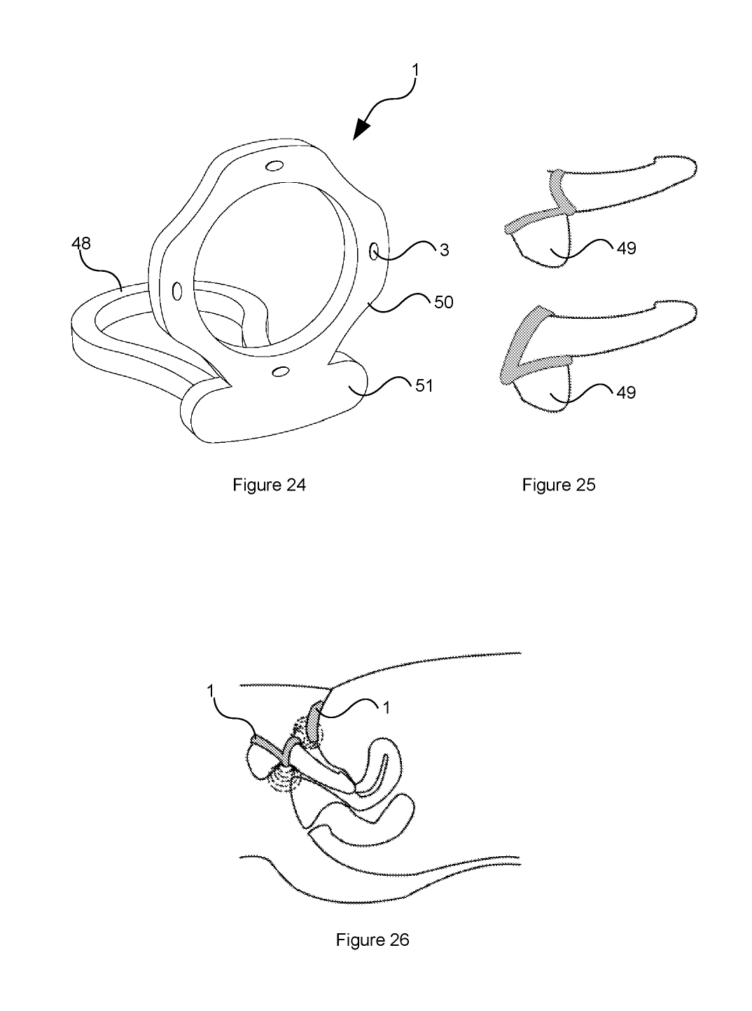

FIG. 24 shows a further embodiment of a male wearable comprising a cock ring wearable 1 which, in an embodiment, may comprise a securement portion 48 which, as is shown in the embodiment in FIG. 25, may secure about the scrotum 49 of the male partner in use while the ring 50 of the cock ring wearable 1 locates about the base of the shaft of the penis. In accordance with this embodiment, the front face of the ring portion 50 comprises a plurality of detector 3.

Furthermore, the cock ring wearable 1 may comprise housing 51 there underneath which may comprise the stimulation device 2 so as to provide stimulations to the male user.

FIG. 26 shows an exemplary utilisation of the cock ring wearable 1 interfacing with a female wearable 1.

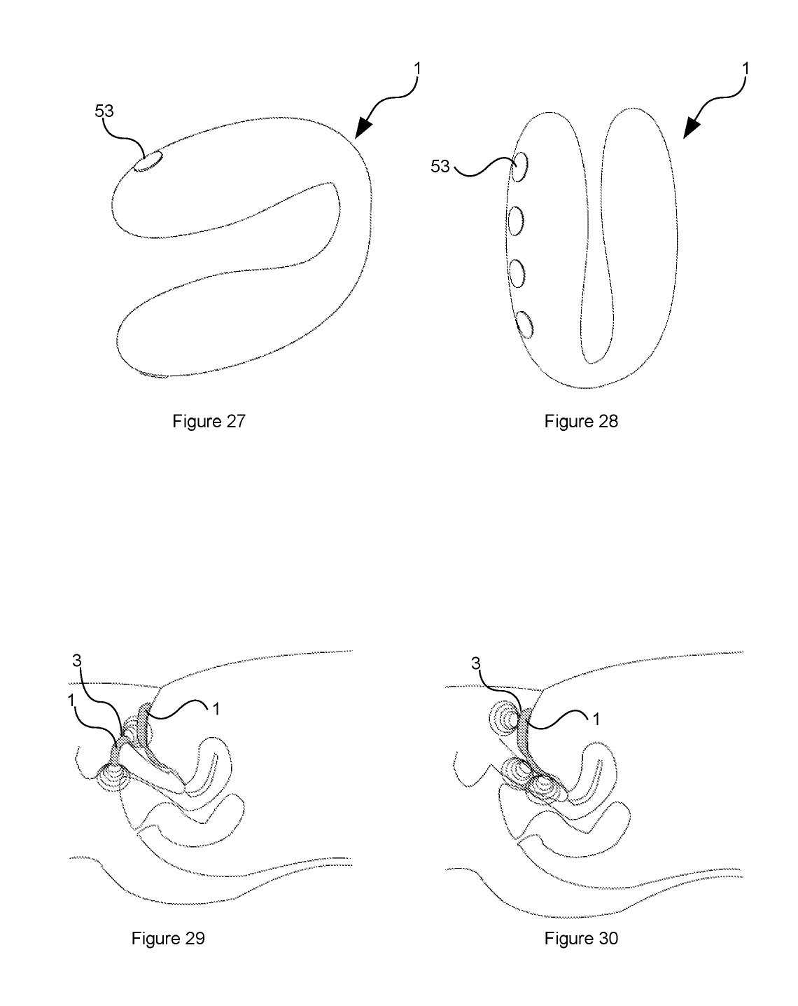

FIG. 27-30 show a further embodiment of a U-shaped semi insertable female wearable 1 which, as can be seen from the in-use embodiments of FIGS. 29 and 30 may be semi insertable in use.

As is substantially shown in FIG. 27, 28, the female wearable 1 may comprise a substantially U-shaped body which may be flexible, so as to open up as is required. There is further shown the female wearable 1 comprising a plurality of sensors 53 thereon, such as on the exterior surface of the wearable 1. The sensors 53 may comprise the intercourse proximity sensors/emitter 3 and or other types of sensors (including those of the peripheral devices 23 shown in FIG. 5).

The embodiment shown in FIG. 29 shows an emitting male wearable 1 and a female receiver wearable 1. The embodiment shown in FIG. 30 shows only a female wearable 1 being utilised wherein the wearable comprises both emitters and sensors 3. As is shown in FIG. 30, the female wearable 1 may comprise both emitters and sensors 3 facing the male partner at the exposed end of the wearable 1 whereas the inserted end of the wearable 1 may comprise contact sensors 24 configured for determining penetration of the penis or the depth of penetration of the penis. As such, in this embodiment, the female wearable 1 may control the stimulator device 2 in accordance with both the intercourse proximity of the male body and the depth of penetration. Furthermore, the intercourse proximity and depth of penetration may be utilised for calculating and arousal state. Additionally, the particular shape of the female wearable 1 of FIGS. 29 and 30 may simultaneously stimulate both the G-spot and clitoris.

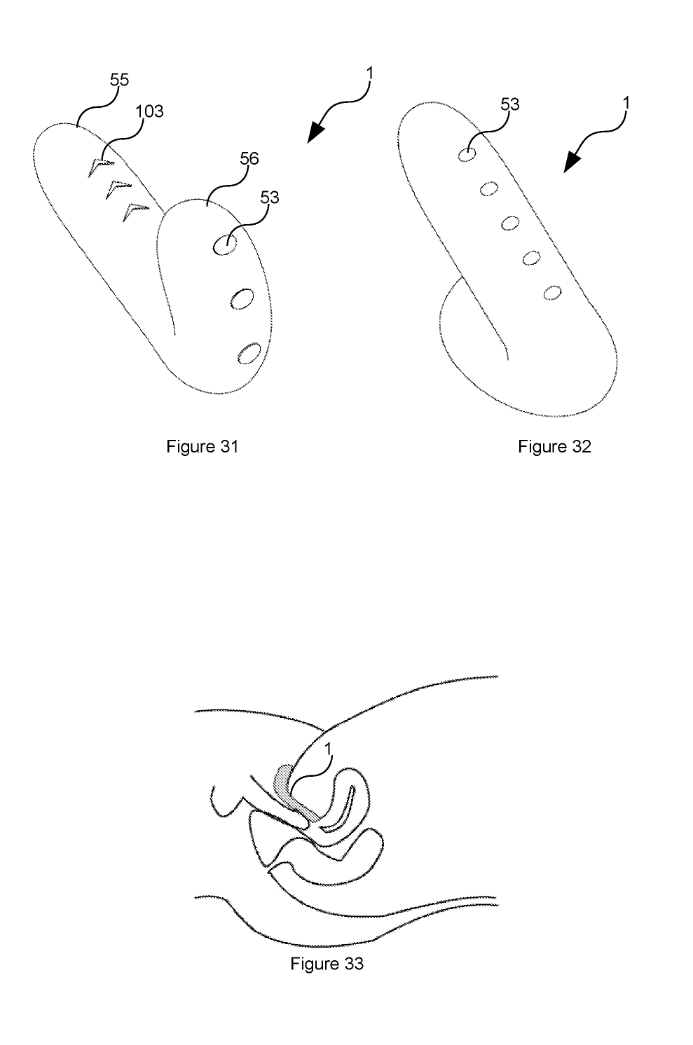

FIGS. 31-33 show a further embodiment of a J-shaped female wearable 1. In this embodiment, the wearable 1 comprises an insertable portion 55 and an exposed portion 56 at an angle thereto. Furthermore, in an embodiment, the insertable portion 55 may comprise a stimulator device 2 configured for stimulating the G-spot whereas the exposed portion 56 may comprise a further stimulator device 2 for clitoral stimulation.

The pair of stimulator devices 2 may be controlled similarly or separately in various applications. Specifically, the female user, such as by utilising the associated mobile device 15 may configure the stimulation of the G-spot and clitoris separately in accordance with user preference. Alternatively, the wearable 1 may control the stimulation of the G-spot in the clitoris separately so as to control the timing of a climax, wherein, for example, to speed the advent of climax, the intensity and/or frequency of the clitoris stimulator device 2 is increased.

In embodiment, the insertable portion 55 may comprise sensors 53 for gauging the depth of insertion of the insertable portion 55 or the penis (wherein the sensors 53 would be on the opposite side). Furthermore, the exposed portion 56 may comprise contact and/or proximity sensors 53 for detecting the partner.

In embodiments, the insertable portion 55 may comprise frictional engagements 103 for retention the wearable 1.

FIG. 33 shows and in use embodiment especially illustrating the configuration of the wearable 1 allowing both penetration and stimulation.

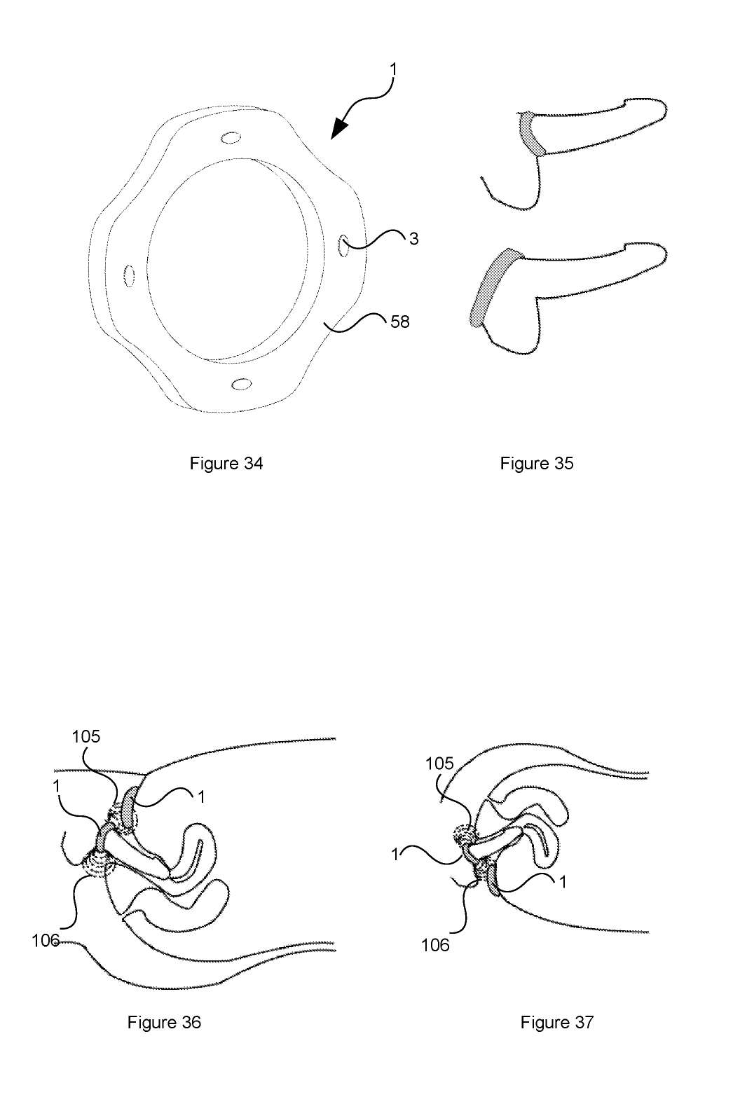

FIGS. 34-37 show a further embodiment of a cock ring male wearable 1. As shown in FIG. 34, the wearable 1 comprises a ring portion 58 which, in an embodiment, may be stretchable so as to accommodate different sizes. The periphery of the ring portion 58 may comprise a plurality of sensors 3, including the intercourse proximity sensor and/or emitter 3. In the embodiment shown in FIG. 35 shows engagement of the cock ring wearable 1 either engaging the shaft of the penis or engaging additionally about of the scrotum.

In use embodiments shown in FIG. 36 and FIG. 37 show how the various sensors/emitters around the male wearable 1 assist the female wearable accurately tracking/detecting penetration regardless of couple's sexual position.

For example, FIG. 36 displays the positioning of the male and female's torsos facing one another while engaged in intercourse. Proximity emissions 105 emanating from top of the male wearable 1 are relatively close to the female wearable 1 therefore aiding in the detection thereof. In contrast, FIG. 37 shows a position where the female's torso is facing the ground and the male is penetrating the vagina from the rear. In this situation proximity emissions 106 emanating from the base of the male wearable 1 (near scrotum) are relatively close to the female wearable 1 aiding the detection thereof in this position. As such, the emissions from both the upper 105 and lower 106 of the male wearable 1 assist in the detection thereof by the female wearable 1 no matter the sex position.

The embodiments provided in FIGS. 12 and 13 may operate similarly since magnetic flux emanate from the entire periphery of the male wearable 1 and therefore may be detectable irrespective of the sex position. In the embodiments of FIGS. 24, 34 and 42 the male wearable 1 may have peripherally located detectors 3 having both emitters 3E and sensors 3S which may assist position-invariant detection.

Furthermore, in embodiments, the male wearable 1 may comprises both emitters 3E and sensors 3S so as to be able to gauge, for example, oral sex penetration, wherein the male wearable 1 may wirelessly transmit proximity data to the female wearable 1 for corresponding stimulation.

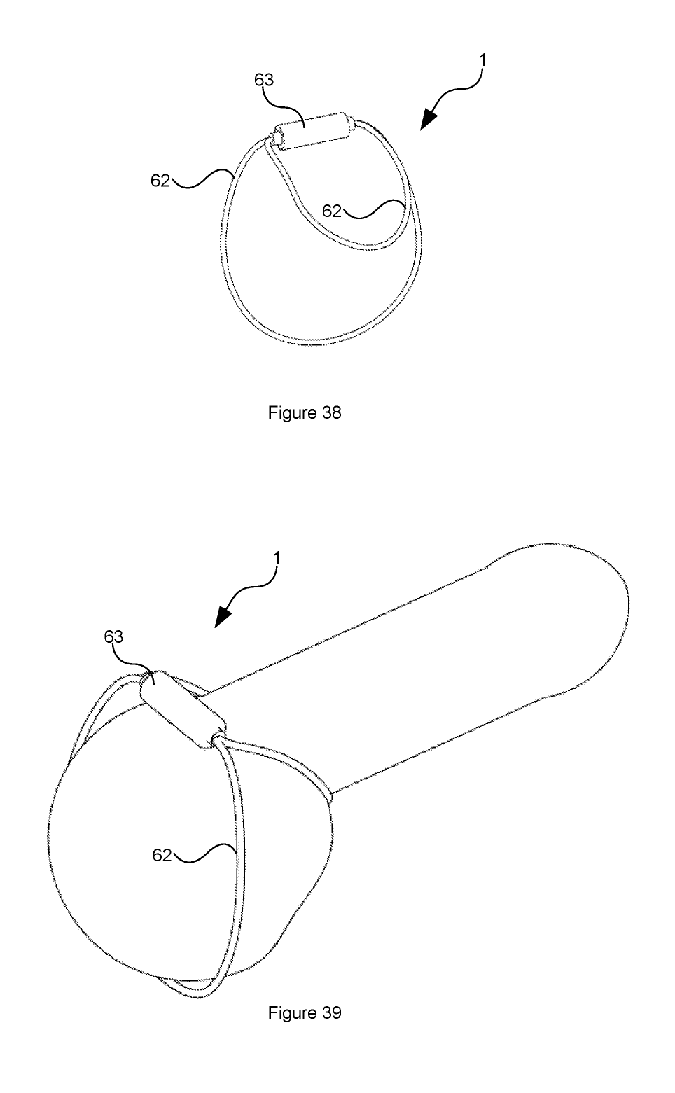

FIGS. 38 and 39 show a further embodiment of a strap on male wearable 1 comprising of light diffusing fibres 62 securing a substantially cylindrical housing 63 comprising electronic componentry therein. For example, light diffusing fibre optic straps connected to the housing having a light emitter such as LED or Laser of a specific frequency of light. The light diffusing fibre of 62 is able to evenly diffuse the light around the base of the penis. The diffusing light around the base of the penis provides the same aforementioned benefit of enhanced detection by a female wearable regardless of sexual position. The use of a specific frequency of light may avoid interference from other light sources. The embodiment shown in FIG. 39 shows an exemplary engagement of the penis wherein a shorter strap 62 engages about the shaft and a longer strap 62 engages underneath the scrotum. In embodiments, as opposed to emitting light, the straps 62 may induce a magnetic flux or electrical current which is detected in a similar fashion.

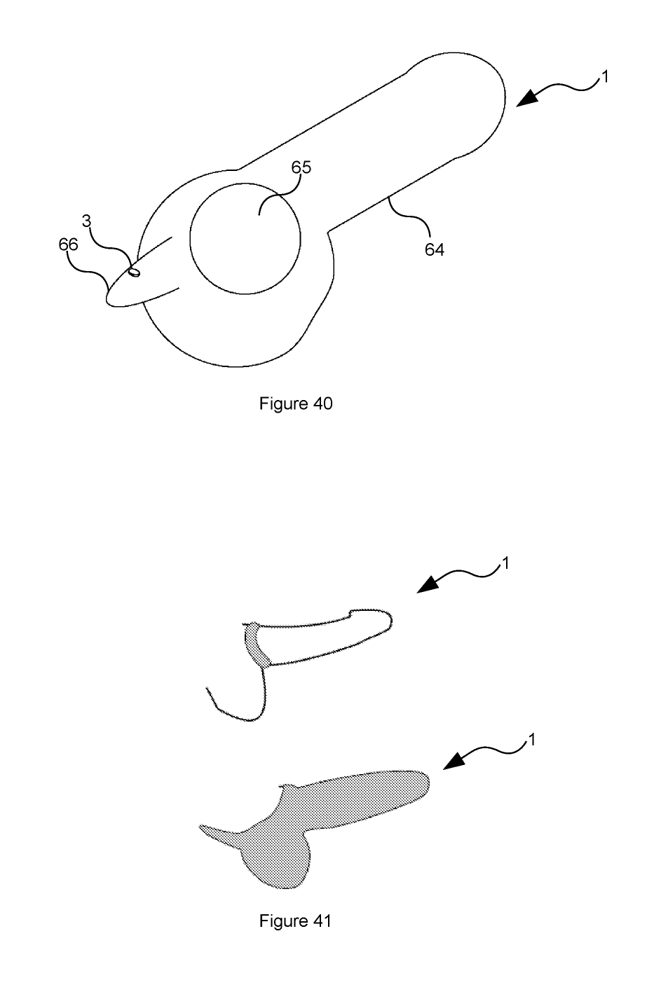

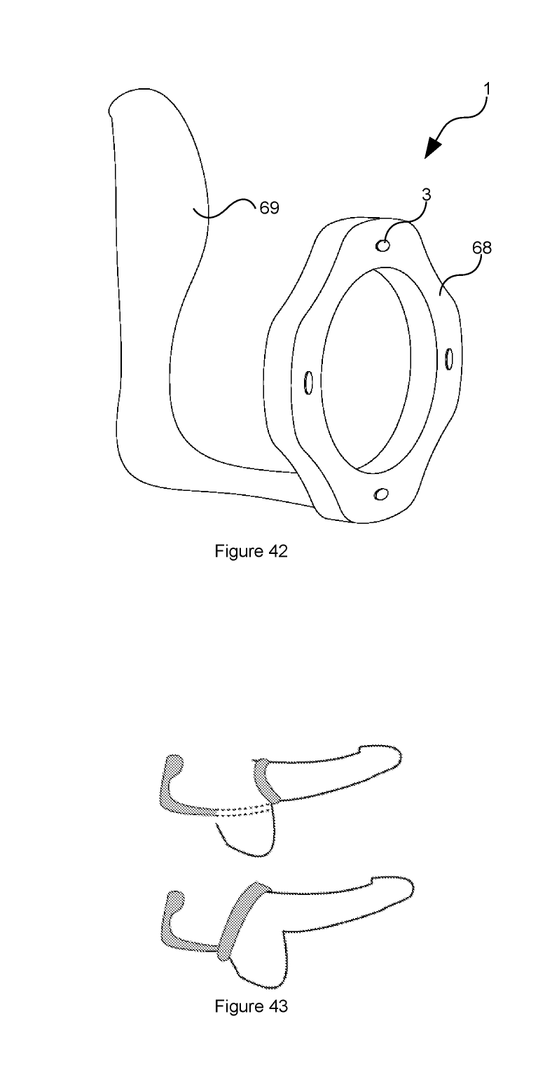

FIGS. 40 and 41 show a further embodiment of a male sleeve wearable 1 comprising a flexible sleeve 64 which surrounds the penis and scrotum. The sleeve 64 defines an aperture 65 for inserting the penis into the sleeve 64. The sleeve 64 may provide mechanisms for stimulation at various points such as along the shaft of the penis, the penis head or the scrotum area or a combination of all. For example, a series of vibrators placed down the penis shaft and within the base of the scrotum area. In addition, the wearable 1 may be connected to an external pump to provide a means for suction and pressure stimulation. The rear of the sleeve 64 may comprise a rubberised housing 66 which may house various componentry, including stimulator device control circuits, power sources and/or various sensors, such as the intercourse proximity sensor and/or emitter 3, including for assists in detecting anal penetration. Furthermore, the sleeve 64 may be a partial sleeve 64 encompassing only specific regions for stimulation, such as the penis shaft, scrotum or the like.

The embodiment shown in FIG. 41 shows an exemplary in use embodiment between two male partners wherein, for example, a first partner utilises a cock ring style wearable 1 and the second partner whereas the sleeve wearable 1. As alluded to above the stimulation is controlled according to the proximity between the two devices.

FIG. 42 shows a further embodiment of a male wearable 1 comprising a cock ring portion 68 operably coupled to an anal plug 69. Similarly, the forward face of the cock ring portion 68 may comprise a plurality of various detectors 3. Furthermore, the anal plug 69 may comprise the stimulator device 2 to provide anal stimulation. As alluded to earlier the detector 3 may utilize combined line of sight emitter and sensor to detect partner's body to drive anal stimulation.

FIG. 43 shows an exemplary and use application showing how the male wearable 1 is engaged, either around the penis shaft or alternatively additionally around the scrotum.

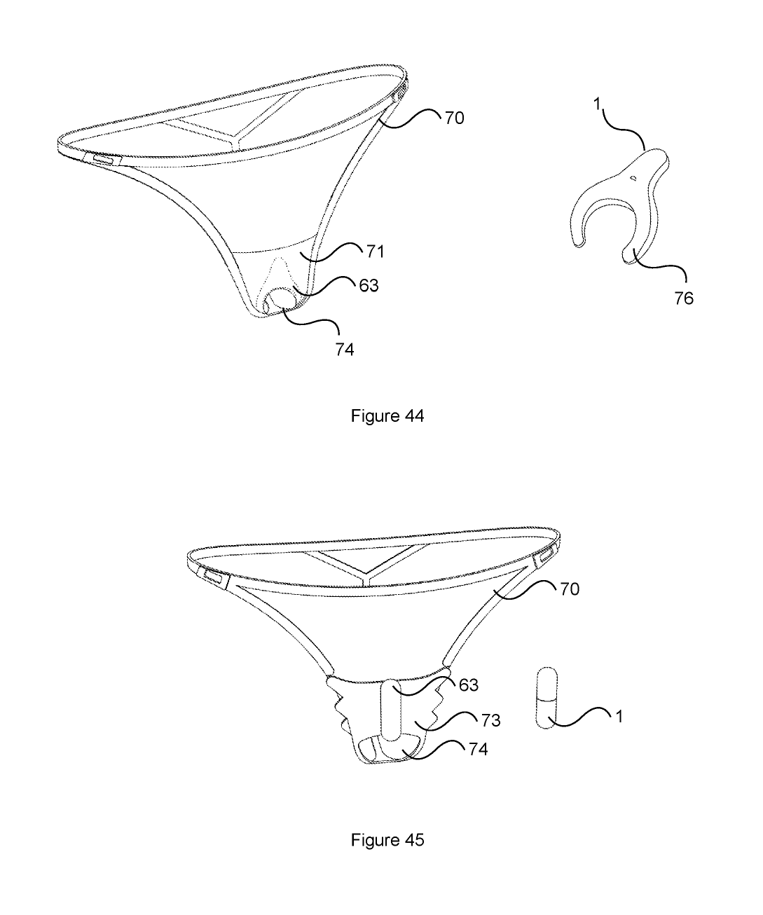

FIGS. 44, 45 show a female wearable arrangement comprising a pair of panties 70 comprising a securement 71 having a pocket 63 for the wearable 1. The wearable 1 may be releasably held in the pocket 63 so as to hold the wearable 1 against the clitoris. In the embodiment shown in FIG. 45, the securement 71 comprises semirigid (such as rubberised) laterally projecting wings 73 for spreading the vibrations to peripheral regions of the vagina. As is shown, the engagement 71 yet provides an aperture 74 allowing for the penetration of the penis there through in use.

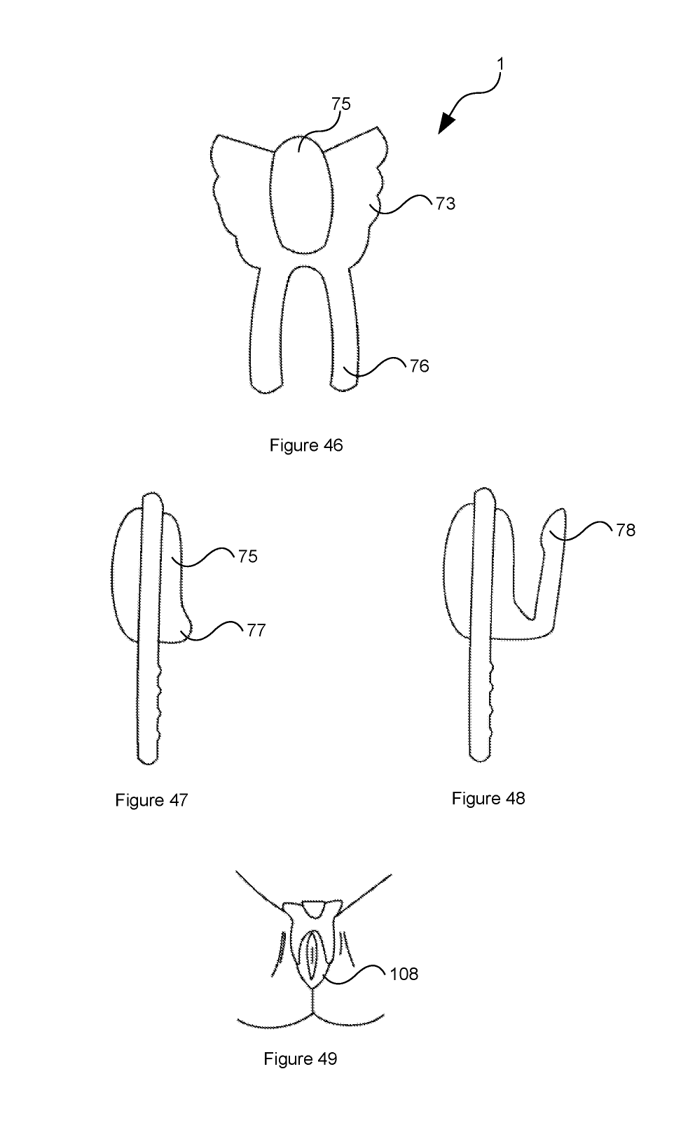

FIGS. 46-48 show further embodiments of a wearable 1 wherein, as is shown in FIG. 46, the wearable 1 comprises a central housing 75 which may comprise the stimulation device 2. As alluded to above, peripherally radiating wings 73 radiate therefrom so as to spread the vibration from the housing 75. The wearable 1 may further comprise inferior spreaders 76 or may house miniature stimulators such as vibration motors to provide labial stimulation and vertical stability as a substantially shown in FIG. 49.

In the embodiment shown in FIG. 47, the housing 75 may define a rearward projecting clitoris protrusion 77 for clitoris stimulation whereas the embodiment shown in FIG. 48 shows an insertable portion 78 which may be inserted into the vagina. Similar protrusions may be applied to stimulators 1 shown in FIGS. 44 and 45 for vertical stability.

FIG. 49 shows an exemplary use of the wearable 1 of FIG. 46 being used by a female and wherein strapping around hips and buttocks 108 may provide securement for the wearable 1.

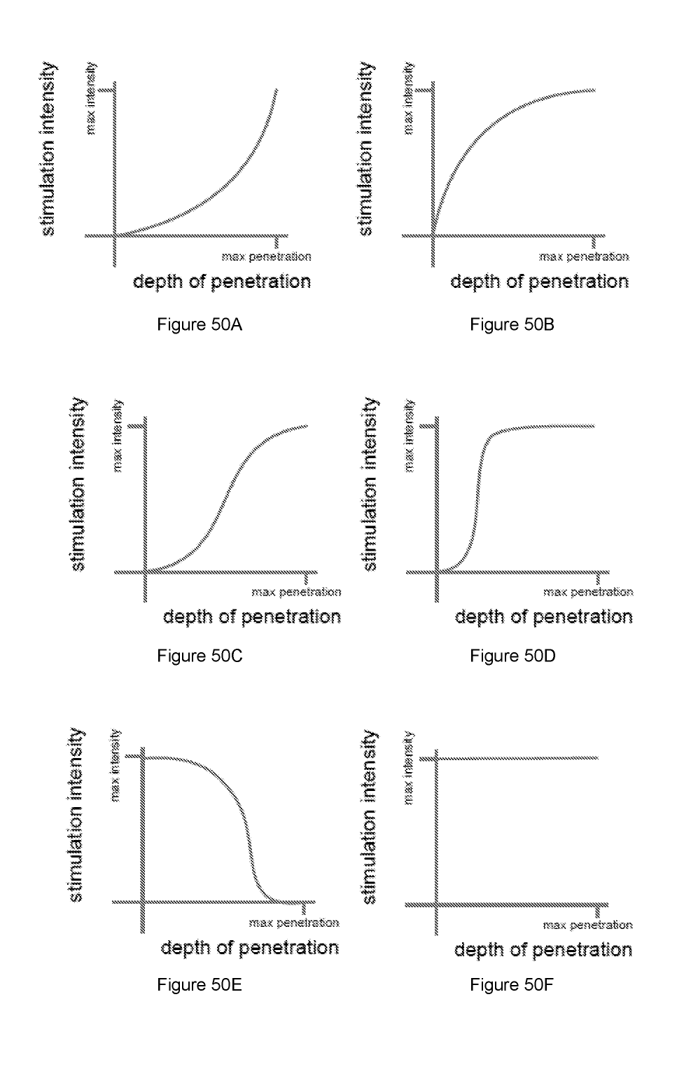

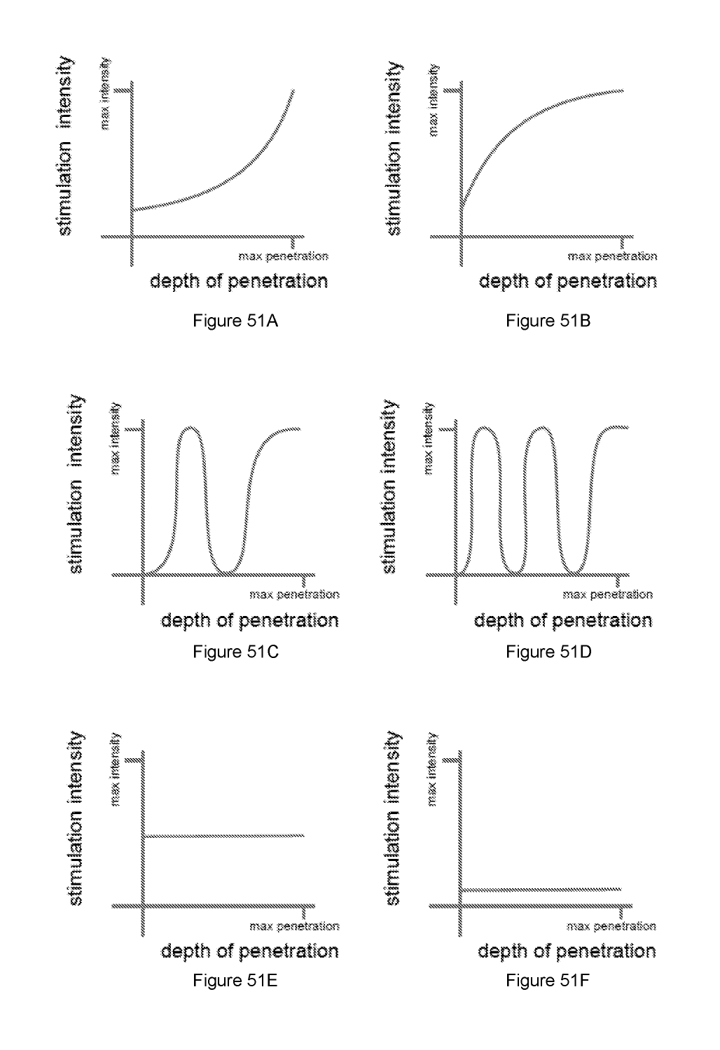

FIGS. 50 and 51 show different manners by which the control circuit 5 may control the stimulation device 2 in accordance with the intercourse proximity 4 (represented as depth of penetration in the figures). Further to this, the system 6 may detect the frequency of penetration and apply stimulation either in phase, out of phase or even in phase shifted to the one detected.

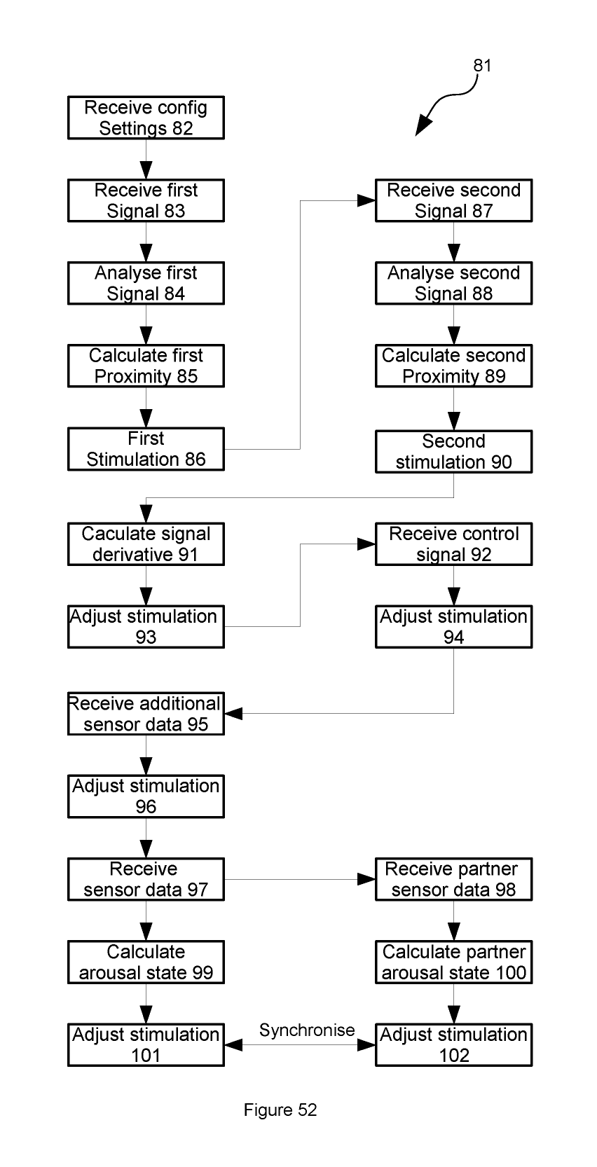

Turning now to FIG. 52, there is shown various processing by the control circuit 5 which is provided primarily for illustrative convenience. In this regard, it should be noted that the functionality shown in FIG. 52 is illustrative and therefore, in embodiments, the circuitry 2 need not perform all of the functionality shown, or utilising the same sequence.

The processing 81 may comprise the wearable 1 receiving configurations settings 82 such as from an associated mobile device 15, or controller 11 or an integrated tactile input on the device (e.g. a button). As alluded to above, such configurations settings may comprise various operational parameters, such as frequency, intensity and the like of the vibrations implement it by the stimulation device 2 so as to control the reaching of climax, and the timing thereof.

The wearable 1 may thereafter receive a first signal 83 utilising the proximity sensor and/or emitter 3 and analyse the first signal 84 so as to be able to calculate a first proximity 85 and so as to be able to control the stimulation device 22 implement a first stimulation 86.

In embodiments, process steps 87-90 may be provided to provide a second stimulation in accordance with a second proximity. For example, the wearable 1 may be configured to implement differing stimulation in frequency and/or intensity according to differing degrees of intercourse proximity 4. For example, the control circuit 5 may control the stimulation device 5 to provide low-level stimulation wherein the partner is close by but to increase the vibrational intensity during penetration wherein the vibrational intensity during penetration is in accordance with the depth of penetration determined utilising the sensor and/or emitter 3 and or other sensors.

The processing 81 may comprise calculating a signal derivative 91 and adjusting the stimulation 93 accordingly. For example, the control circuit 5 may calculate a penetration frequency so as to be able to control the stimulation intensity accordingly.

The processing 81 may further comprise receiving a control signal 92 and adjusting the stimulation 94 accordingly. For example, the female user may utilise the mobile device 15 wirelessly coupled to the wearable 1 to adjust the stimulation frequency and/or intensity of the stimulation device 2. In this manner, the female may adjust the amount of stimulation so as to be able to control the reaching of climax and also the timing of climax in embodiments. As also alluded to above, the control signal may be received from a sensor 12 so as to, for example, be able to control the wearable 1 in accordance with a partner's hand gestures or other body movements.

The processing 81 may further comprise the control circuit 5 receiving additional sensor data 95 and adjusting the stimulation 96 accordingly. For example, the additional sensors may comprise those additional sensor shown in FIG. 3 such as the contact sensor 24, motion sensor 25 temperature sensor 26 and the like. In this embodiment, the control circuit 5 may control the stimulation device to additionally (or alternatively) to the penetration proximity 4.

The processing 81 may further comprise the receipt of the sensor data 97 for the purposes of calculating and arousal state 99 of the user. For example, as alluded to above, the sensor data 97 may comprise various arousal indicative parameters, such as temperature, audible output, heart rate, blood pressure and the like so as to be able to estimate and arousal state of the wearer accordingly. As such, the stimulation implemented by the stimulation device 2 may be controlled in accordance with the state of arousal so as to ensure, or bring forward or defer climax.

The processing 81 may further comprise receiving sensor data 98 for the purposes of calculating a partner arousal state 100 so as to be able to synchronise the climax of the partners. In this manner, the stimulation device 2 of the female wearable 1 (and, in embodiment, the stimulation device 2 of the male wearable 1) may be adjusted such that the male and female reach climax substantially simultaneously. In embodiments, the compilation of the arousal state need not necessarily utilise sensor data wherein, for example, the control circuit 5 may determine the usual time taken for a wearer to reach climax (such which may be provided by post sex feedback via the mobile device 15) or alternatively by user input during intercourse wherein, for example, the male may utilise the controller 11 to indicate such.

It should be noted that whereas stimulation is primarily described above with reference to vibratory-type stimulation, other forms of physical stimulation are envisaged within the purposive scope including vibrational, mechanical, pressure, suction or even electrical or temperature-based stimulation. Such stimulation may be provided to multiple areas or erogenous zones to either body of the users, either in singularity or simultaneously. For example, stimulators could target areas such as clitoral stimulation, the Grafenberg spot (G-spot), anal stimulation, nipple stimulation, labia simulation, prostate stimulation and/or erogenous zones (e.g., neck, legs, buttocks).

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1-32. (canceled)

33. A body mountable inter-couple proximity sensitive stimulation system for use during intercourse, the system comprising:
a stimulator wearable, the stimulator wearable comprising:
a housing configured for being worn by a wearer during intercourse with a partner yet while allowing sexual penetration by the partner;
an erogenous zone stimulation device supported by the housing,
a sex partner intercourse proximity detector supported by the housing, the proximity detector configured for detecting an intercourse proximity in use;
a control circuit operably coupled between the intercourse proximity detector and the stimulation device and wherein the control circuit is configured for controlling the stimulation device according to the intercourse proximity.

34. The system as claimed in claim 33, wherein the intercourse proximity detector is configured for detecting a distance between the stimulator wearable and the body of the partner, optionally wherein the proximity detector comprises an emitter and a receiver (for example, a light emitter and a light sensitive receiver, the light emitter optionally emitting one or more of infrared and ultraviolet light) and wherein the proximity detector is configured for calculating the proximity distance using a reflected signal.

35. The system as claimed in claim 33, further comprising a partner wearable and wherein the proximity detector is configured for detecting the distance between the stimulator wearable and the partner wearable.

36. The system as claimed in claim 35, wherein the proximity detector comprises a magnetic flux detector, for example wherein the proximity detector comprises a Hall effect transducer sensor.

37. The system as claimed in claim 36, wherein the partner wearable comprises a magnet or wherein the partner wearable comprises a ring portion and a plurality of magnets located around the periphery of the ring portion.

38. The system as claimed in claim 35, wherein the proximity detector comprises a light receiver configured for receiving a light signal emitted by the partner wearable and wherein the proximity detector is configured for calculating the intercourse proximity in accordance with the signal strength of the light signal.

39. The system as claimed in claim 33, wherein the wearable comprises an insertable portion and a plurality of contacts sensors there along and wherein the contacts sensors are wearer facing and wherein the stimulator wearable calculates a depth of insertion utilising the contact sensors or wherein the wearable comprises an insertable portion and a plurality of contacts sensors there along and wherein the contact sensors are partner facing and wherein the stimulator wearable calculates a depth of penetration utilising the contact sensors.

40. The system as claimed in claim 33, wherein system is configured for detecting and arousal state of the wearer and controlling the stimulation device according to the arousal state optionally, wherein the wearable stimulator comprises a sensor, for example at least one of a temperature, audio, heart rate and blood pressure sensor, and wherein the arousal state is calculated in accordance with sensor data received via from the sensor, and optionally, wherein the system is configured for detecting an arousal state of the partner and controlling the stimulation device to synchronise the timing of climax of the wearer and the partner according to the arousal state of the wearer and the partner.

41. The system as claimed in claim 33, wherein the control circuit is configured for detecting a first intercourse proximity and controlling the stimulation device in accordance with a first vibratory configuration setting and detecting a further intercourse proximity and controlling the stimulation device in accordance with a second vibratory configuration setting.

42. The system as claimed in claim 33, wherein the control circuit is configured for calculating a proximity distance derivative and controlling the stimulation device in accordance with the proximity distance derivative, wherein the proximity distance derivative optionally comprises at least one of frequency and acceleration.

43. The system as claimed in claim 33, wherein the stimulator wearable comprises a further stimulation device and wherein the control circuit is configured for controlling the stimulation device and the further stimulation device separately.

44. The system as claimed in claim 43, wherein the stimulator wearable comprises an insertable portion and an exposed portion and wherein the insertable portion comprises the stimulation device and wherein the exposed portion comprises the further stimulation device and wherein the control circuit is configured for controlling the stimulation device independently, for example for G-spot stimulation and the exposed portion for clitoral stimulation.

45. The system as claimed in claim 43, further comprising at least one auxiliary stimulator wearable in operable communication with the stimulator wearable and wherein the auxiliary stimulator wearable further comprises a further stimulation device and wherein the stimulator wearable is configured for controlling the auxiliary stimulator wearable for controlling the stimulation device accordingly.

46. The system as claimed in claim 33, wherein the stimulator wearable comprises a motion sensor and wherein the control circuit is configured for controlling the stimulation device in accordance with motion detected by the motion sensor, wherein the motion sensor optionally comprises at least one of an accelerometer and a gyroscopic transducers.

47. The system as claimed in claim 35, wherein the proximity detector comprises a wireless receiver and wherein the partner wearable comprises a detector comprising both an emitter and a sensor configured to detect signal reflected by the wearer's body and wherein the partner wearable is configured for transmitting a signal indicative of the intercourse proximity to the wireless receiver.
